(19) United States
(12) Patent Application Publication
(10) Pub. No.: US 2006/0057251 A1
(43) Pub. Date: Mar. 16, 2006

(54) Mid-level protein distillers dried grains with solubles (DDGS) - production and use

(76) Inventors: Larry Dawley, Shawnee, KS (US); James R. Dawley, Carthage, MO (US)

Correspondence Address: HOWARD J. GREENWALD P.C., 349 W. COMMERCIAL STREET SUITE 2490, EAST ROCHESTER, NY, 14445-2408, US

(21) Appl. No.: 11/268,146

(22) Filed: Nov. 7, 2005

Related U.S. Application Data
(63) Continuation-in-part of application No. 10/463,455, filed on Jun. 17, 2003, now Pat. No. 6,962,722.
Application No. 10/463,455 is a continuation-in-part of application No. 10/000,319, filed on Dec. 4, 2001, now abandoned.

(51) Int. Cl. A23K 1/00

(52) U.S. Cl. 426/53

(57) ABSTRACT

The present invention relates to the production of a highly digestible, mid-level protein DDGS from corn endosperm, and more particularly to a method for the recovery of mid-level protein DDGS by using: (i) dehulling and degermination to isolate a low fat, low fiber corn endosperm fraction, (ii) enzymatic hydrolysis to solubilize and alcoholic fermentation to assimilate the starch and non-starch carbohydrates present in the corn endosperm, and (iii) filtration, centrifugation and/or evaporation to recover the dealcoholized insoluble and soluble solids that remain after fermentation of the corn endosperm. The product of the present invention contains less than about 5.0 weight percent starch, from about 40.0 to about 52.5 weight percent protein, from about 4.5 to about 8.5 weight percent fat, from about 3.0 to about 6.0 weight percent crude fiber, and from about 78.0 to about 90.0 percent total digestible nutrients.

### CROSS-REFERENCE TO RELATED APPLICATIONS

This application is a continuation-in-part of applicants' co-pending patent application U.S. Ser. No. 10/463,455, filed on Jun. 17, 2003, which is a continuation-in-part of U.S. Ser. No. 10/000,319, now abandoned, filed on Dec. 4, 2001.

### FIELD OF THE INVENTION

The present invention relates to the production of a highly digestible, mid-level protein distillers dried grains with solubles (or mid-level protein DDGS) from corn endosperm, and more particularly to a method for the recovery of mid-level protein DDGS by using: (i) dehulling and degermination to isolate a low fat, low fiber corn endosperm fraction, (ii) enzymatic hydrolysis to solubilize and alcoholic fermentation to assimilate the starch and non-starch carbohydrates present in the corn endosperm, (iii) filtration and/or centrifugation to recover the dealcoholized insoluble solids that remain after fermentation of the corn endosperm, (iv) evaporation to concentrate the dealcoholized soluble solids that remain after fermentation of the corn endosperm, and (v) mixing and drying together the dealcoholized insoluble and soluble solids remaining after fermentation of the corn endosperm. The present invention provides an alternative to the traditional dry mill method of processing corn to produce ethanol, and results in the production and recovery of a distillers' by-product (mid-level protein DDGS) that contains less than about 5.0 weight percent starch, from about 40.0 to about 52.5 weight percent protein, from about 4.5 to about 8.5 weight percent fat, from about 3.0 to about 6.0 weight percent crude fiber, and from about 78.0 to about 90.0 percent total digestible nutrients. The product of the invention is used as an ingredient to improve the palatability and digestibility of animal feeds and/or pet foods, and aid in the management of the health and weight gain of the animal.

### BACKGROUND OF THE INVENTION

The processing of corn to produce: (a) protein, fiber and fat-containing ingredients for the feed industry, (b) grits, meals, flours, starches and/or syrups for food manufactures, and (c) binders, film-formers, and adhesives for technical industries is done using either a wet or dry milling process. In the wet-milling process, corn kernels are steeped for 30 to 40 hours in a warm solution of water and sulfur dioxide. During steeping, the corn kernels absorb water (swell) and soften, thereby loosening the matrix that holds the protein, fiber, germ and starch components together. After steeping, the corn is coarsely ground to break the embryo (germ) loose from the other components. The ground corn is then pumped to hydrocyclones that spin the low-density corn germ out of the slurry. The germ is washed to remove excess starch, dried, and further processed with mechanical and/or solvent processes to extract corn oil. The heavy phase/slurry leaving the germ separators is ground more thoroughly in an impact or attrition mill to release the starch and protein from the fiber present in the kernel. The suspension of starch, protein and fiber is then pumped over screens that recover the fiber, but allow starch and protein to pass through. The fiber is washed to remove any residual starch or protein, combined with the defatted germ and concentrated steepwater, and dried to produce corn gluten feed. The starch and protein suspension is then pumped to separators where protein is removed due to its low density compared to starch. The starch is washed to remove last traces of protein. The protein suspension is dewatered and dried producing a 60.0 percent protein product that the industry refers to as corn gluten meal. The clean starch may then be dried or further processed into sweeteners or fermentation chemicals. Corn wet-milling is a capital-intensive process, but the cost of producing starch for further processing is offset by the sale of the resulting co-products; corn oil, corn gluten feed, and corn gluten meal.

The first step of the dry-milling process entails tempering clean corn with water to approximately 20.0 percent moisture. While moist, the outer bran layer or pericarp, the germ, and tip cap loosen their attachment to and are separated from the starchy endosperm. The majority of the corn endosperm, known as the “tailstock”, proceeds through a degerminator, is dried, cooled and sifted. A portion of the endosperm is isolated as large flaking grits. Further separation is accomplished using roller mills, sifters, gravity tables, and aspirators so that an infinite variety of smaller grits, meals, and flours can be produced. The bran and germ are passed through another part of the degerminator as the “throughstock” stream. This stream is dried, sieved, and aspirated to recover the bran. Further processing separates the germ from any remaining endosperm. The “throughstock” produces germ for crude corn oil production; hominy feed; bran products; standard meal; and prime grits, meals, and flours.

Some researchers have developed ways to combine the low cost and speed in which germ, fiber, and endosperm may be separated in corn dry-milling with the efficiency of starch and protein separation provided by corn wet-milling to create a “hybrid” process. For example, U.S. Pat. No. 4,181,748 discloses the dry milling of corn to provide fractions of endosperm, germ, fiber, and cleanings, and the wet milling of the endosperm fraction using two distinct steeping steps to produce a mill starch slurry. In this reference the mill starch slurry is separated into a starch-rich fraction and a protein-rich fraction, and the protein-rich fraction is combined with the germ, fiber, and cleanings fraction from the dry milling process and the offals from starch refining to provide a feed product.

In another reference disclosing the further processing of dehulled and degermed dry milled corn products, U.S. Pat. No. 4,517,022, corn endosperm is slurried with water containing alkali and sodium sulfite, and subjected to high intensity mixing for a period not to exceed four hours. A high quality starch is then recovered.

Due to its availability, relatively low cost, and high starch content, corn also is used as a raw material in the manufacture of fermentation chemicals. Ethanol is one such chemical, and is produced in large volume. Currently, ethanol is produced from corn mainly via two different processes—a wet mill process and a dry-grind process. The wet mill process follows the scheme described above with the resulting clean starch stream undergoing liquefaction, saccharification and fermentation. Ethanol is recovered by distillation and yeast is harvested and sold to feed manufacturers as a source of single cell protein. In the dry-grind process, raw corn is ground to a meal and mixed with water and enzymes. The corn slurry is cooked to gelatinize and liquefy the starch. The cooked slurry or mash is then cooled, a second enzyme is added to saccharify the liquefied starch (produce fermentable sugars), and yeast is added to ferment the sugars as they are produced to ethanol. The fermented mash is then distilled to recover the ethanol. Only starch is fermented to ethanol, the non-fermentable components of the corn (the oil, fiber, and protein) are carried through the process and emerge from distillation in slurry form. This slurry is centrifuged to separate the suspended or insoluble solids from the soluble solids, the insoluble solids being discharged from the centrifuge as a wet cake. The soluble solids are concentrated by evaporation, combined with the wet centrifuged solids, and dried together to produce distillers dried grains with solubles, or DDGS.

A derivation of the dry-grind ethanol process is disclosed in U.S. Pat. Nos. 4,407,955 and 4,448,881. Starch derived from a dry milled cereal grain (the starch in the form of corn endosperm) is hydrolyzed to provide a sterile aqueous fermentable sugar solution. Following an initial hydrolysis to liquefy the starch, substantially all of the water insoluble protein and oil components and a portion of the water-soluble components, e.g. sugars, lipids, proteins, and vitamins, are separately recovered from the hydrolyzate either before or after further hydrolysis of the liquefied starch to provide an aqueous solution of fermentable sugar. Unlike the traditional dry-grind ethanol process the insoluble, non-starch solids are removed prior to fermentation and do not contain yeast and yeast cell fragments, and the resulting minerals, vitamins, and unidentified growth factors contributed by the yeast to the DDGS.

Distillers dried grains with solubles (DDGS) contribute significantly to the economics of the dry-grind ethanol production process. Approximately 16.5 to 18.5 pounds of DDGS are produced from each bushel of corn processed. Its sale enables the ethanol producer to take a credit of $0.60 to $0.90 per bushel against his purchase price of corn. Distillers dried grains with solubles (DDGS) contains 3.5 times the protein (60.0 percent of which is by-pass protein in the rumen digestive system), 5.0 times the fiber (much of which has been made digestible for the rumen digestive system by the features of the process), and 7.0 times the fat of the starting corn. Approximately 85.0 percent of the DDGS produced is used as an ingredient in feeds for dairy cattle. Turkey, poultry, swine, and beef cattle represent expanding, but secondary markets for DDGS.

A significant amount of research has been conducted by animal nutritionists to demonstrate that DDGS produced by dry-grind ethanol production facilities may replace a portion of the corn, soybean meal, and calcium now used to formulate feeds for swine, poultry and beef cattle. The results of this research are that DDGS may be used, up to a certain level, but its selling price must stay in the range of $70 to $100 per ton to provide an incentive for its use. One of the limitations to the greater use of DDGS is its high non-starch carbohydrate content. Non-starch carbohydrates are the primary components of the cell wall, the hull, of cereal grains and are relatively resistant to breakdown by the digestive system of non-ruminants (swine, poultry, fish and pets). This prevents the nutrients entrapped within the cells of many grains and by-products of grain processing from being nutritionally available to the animal.

Enzymes are now being added to feeds to improve their digestibility and nutritional performance. U.S. Pat. Nos. 5,612,055 and 6,162,473 disclose methods to increase the efficiency with which monogastric animals utilize diets containing cereals and cereal by-products. The addition of hemicellulase, protease, and/or beta-glucanase enzymes to the rations increases the efficiency with which monogastric animals utilize the rations (the amount of feed consumed relative to the weight of the animal is reduced).

Other researchers have explored the prospect of further processing DDGS to increase its protein and decrease its fiber content. Wu and Stringfellow (Journal of Food Science. 1982. Volume 47: 1155-1157) reported that pin milling and sieving may be used to isolate a high protein fraction from DDGS. Corn DDGS at 21.0 and 30.0 percent initial moisture protein, respectively, can be ground twice at 14,000 rpm and separated with a 50 mesh screen to obtain a fraction with 43.0 percent protein content in 41.0 percent yield.

There are no reports of a method that entails the dehulling and degerminating of corn to recover low fat, low fiber endosperm at the greatest yield possible (achieved by combining the large, medium and small grits, and the meal and flour streams), and the use of enzymatic hydrolysis to solubilize and alcoholic fermentation to assimilate the starch and non-starch carbohydrates present in this corn endosperm in order to produce a highly digestible, mid-level protein distillers dried grains with solubles (or mid-level protein DDGS). Additionally, there have been no reports of a method to produce a mid-level protein DDGS that is further characterized by its overall low fiber content (crude, acid detergent and neutral detergent fiber combined). Furthermore, there have been no reports of a method combining mechanical removal of corn fiber (bran) and enzymatic hydrolysis and alcoholic fermentation of non-starch carbohydrates to produce mid-level protein DDGS and the subsequent use of that mid-level protein DDGS as an ingredient in feeds for farm-raised ruminants and non-ruminants and in pet foods to improve the palatability and digestibility of animal feeds and/or pet foods, and aid in the management of the health and weight gain of the animal. It is an object of this invention to provide such a method and to also provide the composition produced by such method.

### SUMMARY OF THE INVENTION

In accordance with this invention, there is provided a method for the production of a highly digestible, mid-level protein distillers dried grains with solubles (or mid-level protein DDGS) from corn endosperm, and more particularly to a method for the recovery of mid-level protein DDGS by using: (i) dehulling and degermination to isolate a low fat, low fiber corn endosperm fraction, (ii) enzymatic hydrolysis to solubilize and alcoholic fermentation to assimilate the starch and non-starch carbohydrates present in the corn endosperm, (iii) filtration and/or centrifugation to recover the dealcoholized insoluble solids that remain after fermentation of the corn endosperm, (iv) evaporation to concentrate the dealcoholized soluble solids that remain after fermentation of the corn endosperm, and (v) mixing and drying together the alcoholized insoluble and soluble solids remaining after fermentation of the corn endosperm. The present invention provides an alternative to the traditional dry mill method of processing corn to produce ethanol, and results in the production and recovery of a distillers' by-product (mid-level protein DDGS) that contains less than about 5.0 weight percent starch, from about 40.0 to about 52.5 weight percent protein, from about 4.5 to about 8.5 weight percent fat, from about 3.0 to about 6.0 weight percent crude fiber, and from about 78.0 to about 90.0 percent total digestible nutrients. The product of the invention is used as an ingredient to improve the palatability and digestibility of animal feeds and/or pet foods, and aid in the management of the health and weight gain of the animal.

### BRIEF DESCRIPTION OF THE DRAWINGS

The preferred embodiments of the invention will be described by reference to the following drawings, in which like numerals refer to like elements, and wherein:

FIG. 1 is a schematic diagram depicting the preferred method of dry milling (dehulling and degerminating) corn to maximize the recovery of endosperm and the subsequent fermentation of the endosperm to produce the product of the invention (mid-level protein DDGS); and

FIG. 2 is a schematic diagram illustrating a modification to the method shown in FIG. 1 and showing how the production of high value co-products may be increased with no impact on the yield or quality of the product of the invention (mid-level protein DDGS).

### DESCRIPTION OF THE PREFERRED EMBODIMENTS

The present invention, in one of its embodiments, relates to a process for preparing a highly digestible, mid-level protein DDGS from corn that may be used as an ingredient in feeds for farm-raised ruminants or non-ruminants, or as an ingredient in pet foods. The mid-level protein DDGS results from recovering the insoluble and soluble solids that remain after the alcoholic fermentation and/or solubilization and separation of the starch and non-starch carbohydrates present in the endosperm fraction of dry-milled corn. This endosperm fraction is a high starch, low fat, low fiber component comprised of the large, medium and fine grits, and the meal and flour generated during the dehulling and degermination of corn. The product of the invention is used to improve the palatability and digestibility of animal feeds and/or pet foods, and manage the health and weight gain of a farm-raised ruminant, farm-raised non-ruminant, or pet.

In another embodiment, the invention pertains to a highly digestible, mid-level protein DDGS high protein product that is produced through the alcoholic fermentation of corn endosperm (a high starch, low fat, low fiber fraction obtained from the dehulling and degerminating of corn), and the subsequent use of the mid-level protein DDGS as an ingredient in animal feeds for farm-raised ruminants and non-ruminants and in pet foods. The process for producing the mid-level protein DDGS comprises the steps of: (a) conditioning and tempering corn in water to loosen the attachment of the fractions consisting of the endosperm from the germ from the pericarp (hull); (b) dehulling and degerminating the tempered corn to separate endosperm from the germ from the pericarp (hull) and recovering the endosperm in high yield, keeping the large, medium and fine grits, and the meal and flour generated during degermination as a single distinct fraction; (c) enzymatic hydrolysis to solubilize and alcoholic fermentation to assimilate the starch and non-starch carbohydrates present in the corn endosperm; (d) removing the alcohol produced during the fermentation and separating the solids that remain into an insoluble solids and soluble solids fraction, and; (e) recovering and drying together the insoluble and soluble solids to produce the product of the invention, mid-level protein DDGS.

The composition of mid-level protein DDGS is different from that of DDGS and other distillers' co-products produced from the traditional dry mill ethanol production process, which are obtained through the fermentation of the starch present in whole, ground corn. Whereas, DDGS produced in the traditional dry mill ethanol process has a: (a) protein content of from about 27.0 to about 30.0 percent, (b) fat content of from about 9.0 to about 12.0 percent, and (c) crude fiber content of from about 7.5 to 9.5 percent, the product of this invention, mid-level protein DDGS has a: (a) protein content of from about 40.0 to about 52.5 weight percent, (b) fat content of from about 4.5 to about 8.5 weight percent, and (c) crude fiber content of from about 3.0 to about 6.0 weight percent. Unlike the DDGS produced from the traditional dry mill ethanol production process, which contains a large amount, as much as 35.0 percent of its dry weight, of non-starch carbohydrates (cellulose and arabinoxylans—measured as neutral detergent fiber), mid-level protein DDGS is produced employing processing steps that mechanically removes and enzymatically hydrolyzes the non-starch carbohydrates making mid-level protein DDGS more palatable and digestible to the non-ruminant.

In accordance with this discovery, it is an object of the invention to provide a novel method for producing a highly digestible, mid-level protein DDGS from corn. An additional object is to provide a method for producing mid-level protein DDGS through the fermentation of a high starch, low fat, low fiber material (corn endosperm) produced from the dehulling and degermination of corn.

An additional object of the invention is to provide a method that employs enzymatic hydrolysis to solubilize and alcoholic fermentation to assimilate the starch and non-starch carbohydrates present in the endosperm fraction isolated from corn.

Another object of the invention is to produce a mid-level protein DDGS from corn that is lower in crude fiber, acid detergent fiber, and neutral detergent fiber, than DDGS produced from traditional corn dry mill fermentation processes, and is readily digested by animals possessing either a rumen or monogastric digestive system.

A further object of the invention is to use mid-level protein DDGS as an ingredient in animal feeds and pet foods, providing both a source of energy and protein, to improve the palatability and digestibility of animal feeds and/or pet foods, and manage the health and weight gain of a farm-raised ruminant, farm-raised non-ruminant, or pet.

Still another object of the method is to provide a process for producing a high value co-product (the mid-level protein DDGS) during the production of ethanol from corn, such a co-product, when added to the other co-products capable of being produced from the invention (i.e., corn oil, food-grade corn bran, hominy feed, corn germ, corn fiber oil, and corn fiber gum) and the end-product ethanol, which all have value in the marketplace, will lessen the impact rising corn and energy prices have on the economic viability of corn processing.

Other objects of the present invention will be discussed or will become apparent from the following description.

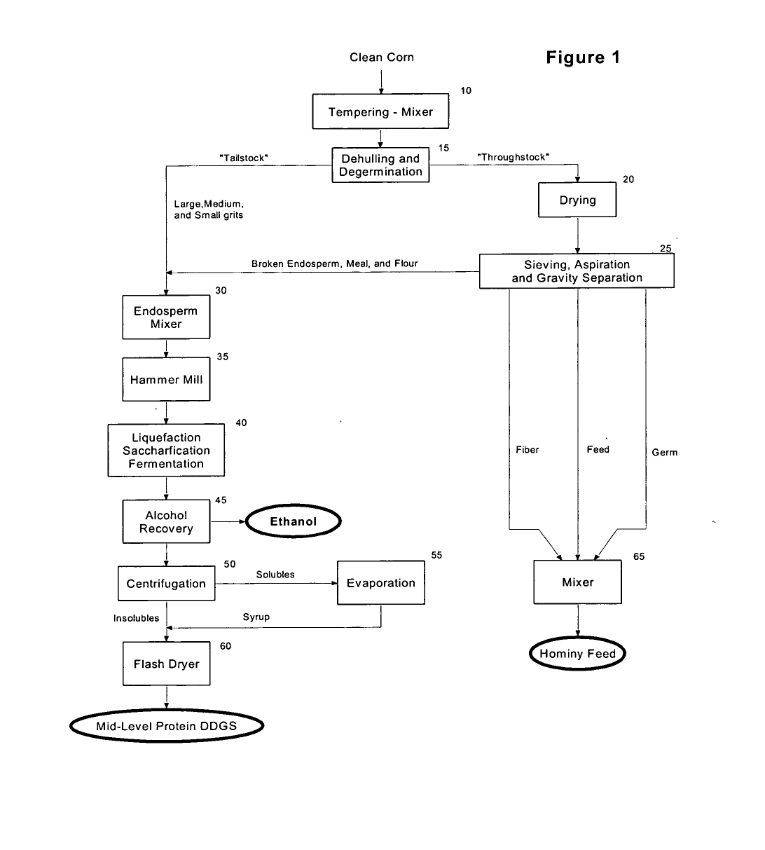

One preferred method for producing a highly digestible, mid-level protein DDGS from an endosperm fraction of dry milled corn is illustrated in FIG. 1.

Referring to FIG. 1, cleaned, conditioned corn (preferably hard endosperm yellow or white corn) is fed from storage to mixer 10 for tempering. Preferably, water at ambient temperature is sprayed onto the surface of the kernels to adjust the moisture content of the cleaned corn from about 12.0 to 15.0 percent to between 17.0 and 22.0 percent. It also is preferred that the corn emanating from mixer 10 be held in a vessel for a period of from 20 minutes to 8 hours, and more preferably for a period of time at least 1 hour (the tempering period). Conditioning followed by a period of tempering: (i) causes the bran coat to separate (peel away) from the vitreous part (the endosperm) of the kernel, (ii) facilitates the separation of germ by making it soft and elastic, thereby preventing it from breaking apart during degermination and adding fat to the endosperm fraction, (iii) reduces the amount of flour produced during degermination, and (iv) obtains the best yield of high starch, low fat, low fiber endosperm.

Referring again to FIG. 1, after tempering the corn kernels are fed into dehulling and degermination device 15 (such devices are manufactured by, but not limited to the impact or conical maize degerminator of Ocrim spa, the vertical maize degerming machine (VBF) of Satake Corporation, and the Beall degerminator of the Beall Degerminator Company) where impact, abrasion, or shearing action separates the endosperm (starch containing) fraction from the germ (oil containing) fraction from the pericarp (bran) fraction. Recovery of the various fractions is done according to their physical characteristics (particle size and density). The coarsest fraction contains large, medium and small particles of endosperm (as measured by their collection on screens ranging in size from 3.5 wire to 14.0 wire), is essentially free of germ, and is aspirated to remove bran and dust. The corn dry-milling industry often refers to the endosperm fraction isolated as large particles as the “tailstock”.

Compared to the endosperm fraction or tailstock, the particles that comprise the germ and pericarp fractions are smaller in size and lighter in weight. The corn dry-milling industry refers to this fraction as the “throughstock”. It should be noted that the separation and recovery of endosperm from dehulling and degermination device 15 is rarely 100.0 percent, and portions of broken endosperm and endosperm that is loosely attached to the germ (mostly in the form of meal or flour) end up being present in the throughstock. The germ and preicarp fractions absorb most of the water during the tempering process. The moisture content of the throughstock must be lowered from 22.5 to 25.0 percent to between 12.0 and 15.0 percent prior to any further processing and is done so in dryer 20. After drying, the throughstock is subjected to sieving, aspiration and gravity separation 25 to remove additional quantities of endosperm (in the form of meal and flour) and generate distinct streams containing germ, fiber, and feed, the latter material comprising fine particles of endosperm, germ, and fiber. The germ, fiber, and feed streams are collected and mixed to produce hominy feed, the by-product of the process of the invention.

The endosperm fraction containing large, medium, and small grits (the tailstock) is combined with the broken endosperm, meal and flour isolated from the refining of the throughstock in endosperm receiver/mixer 30. The total amount of endosperm recovered by the process of the invention is not less than 65.0 percent, and preferably more than 70.0 percent, of the starting material (corn). The total endosperm fraction isolated and recovered by the process of the invention has a fat content from about 0.70 to about 1.20 weight percent and a crude fiber content from about 0.40 to about 0.80 weight percent.

The total endosperm fraction of the process is fed into milling device 35 (a hammer mill) to produce a meal that possesses a range of particle sizes that facilitates fermentation (ethanol yield) and recovery of the solids that remain after fermentation, preferably the total endosperm fraction is ground so that all particles pass a 20 mesh screen. The ground endosperm fraction is then subjected to liquefaction, saccharification, and fermentation 40; a process that encompasses: (a) the preparation of a slurry or mash, accomplished by adding, under vigorous agitation, the ground endosperm to recycled process water and/or fresh water (b) cooking of the slurry or mash at a temperature of at least 95 degrees Celsius to gelatinize the starch, (c) the addition of a liquefying enzyme (commercially available alpha amylase, preferably selected from those that function at high temperature, low pH, and require low levels of calcium) to solubilize the starch present in the ground endosperm, (d) the addition of saccharifying enzymes (any commercially available glucoamylase marketed for use in fuel and beverage-grade ethanol production, and, if warranted, an enzyme preparation possessing a range of activities that includes, but is not limited to, cellulase, xylanase [hemicellulase], and beta-glucanase) to produce fermentable sugars from the starch and solubilize the non-starch carbohydrates present in the endosperm, and (e) the addition of a distillers yeast (belonging to the family of Saccharomyces sp. or Candida sp.) or a fermentative bacterium (Zymomonas mobilis) to convert the fermentable sugars to ethanol.

The fermented mash from alcoholic fermentation 40 is then transferred to alcohol recovery 45 where physical separation methods such as distillation and dehydration or membrane filtration (pervaporation) and dehydration are employed to recover ethanol. The slurry that remains after alcohol recovery contains non-fermentable solids. These solids are insoluble (suspended) and soluble (dissolved) in nature. The slurry is processed through centrifugation device 50 (preferably a decanter centrifuge, but a screw press or filter press also may be used) to separate the insoluble solids (including spent yeast) from the soluble solids. The suspended or insoluble material is recovered by device 50 at a solids content not less than 30.0 percent and are conveyed to dryer 60 (such as a flash, fluidized bed, or rotary dryer), where they are mixed with a syrup (generated via evaporator 55) comprised of the soluble solids of the fermentation process and dried to 10.0 percent moisture to generate the product of the invention (mid-level protein DDGS). The product of the invention has a: (a) protein content of from about 40.0 to about 52.5 weight percent, (b) fat content of from about 4.5 to about 8.5 weight percent, (c) crude fiber content of from about 3.0 to about 6.0 weight percent, and (d) total digestible nutrient value of from about 78.0 to about 90.0 percent.

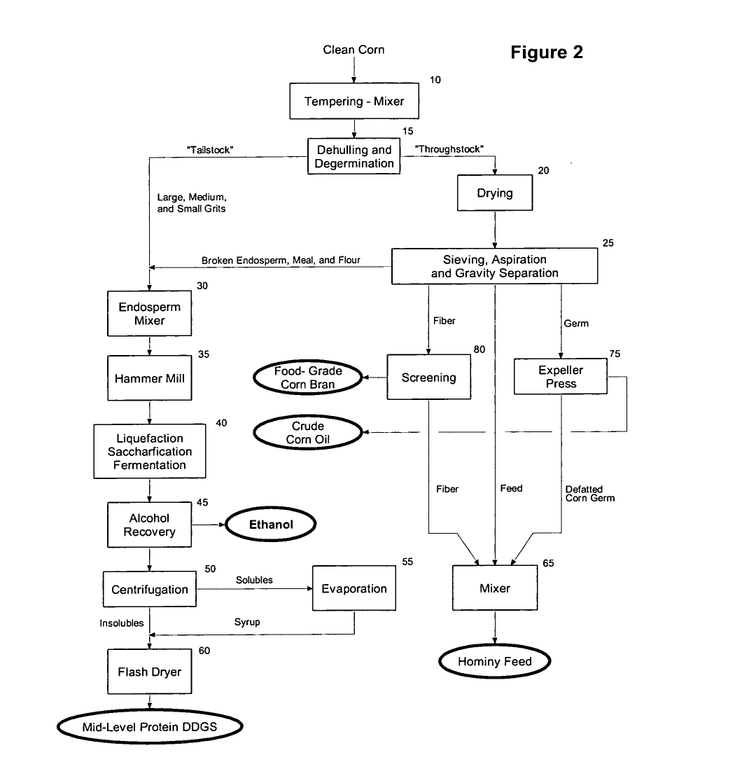

FIG. 2 depicts a modified version of the method described in FIG. 1. The primary difference between the modified method of FIG. 2 and that of FIG. 1 relates to the further processing of the throughstock fraction in order to produce additional co-products from the process of the invention. Much interest exists in improving the economics of manufacturing ethanol from corn in a dry milling process so businesses that employ the corn dry mill ethanol process remain viable during periods of increasing corn and energy prices. Most developmental efforts have focused on the isolation, recovery and sale of the non-fermentable components of the grain. In the FIG. 2 method, the germ isolated during sieving, aspiration and gravity separation 20 is subjected to expeller pressing 75 (such equipment is offered by Anderson International Corporation or French Oil Machinery Company) to produce crude corn oil. The crude corn oil may be sold to edible oil refiners in the domestic and export market. Additionally, in the FIG. 2 method, the fiber isolated during sieving, aspiration and gravity separation 20 is subjected to screening 80 to withdraw a stream that possesses a high dietary fiber content, minimum of 80.0 percent on a dry substance basis. This material is marketed as food-grade corn bran and may be used in a myriad of products such as breakfast cereals, snack foods, baked goods, and dietary or nutritional supplements.

Compared to the distillers' co-products produced by the prior art, the process of this invention produces a product (mid-level protein DDGS) that is far superior in meeting not only the nutritional requirements of farm-raised ruminants (dairy and beef cattle), but also those of the farm-raised non-ruminant (swine, poultry, and fish) and domestic pet (dog and cat). The stellar properties of mid-level protein DDGS are a function of its high digestibility, high protein content (50.0 percent greater than that of the DDGS produced by plants using the traditional corn dry mill ethanol process), high availability of amino acids (particularly methionine), and lower fiber content (as much as one half of the crude plus acid plus neutral detergent fiber of that found in the DDGS produced by plants using the traditional corn dry mill ethanol process). The process of the present invention allows for the production of up to four co-products, plus ethanol, during the fermentation of corn, compared to just one co-product, DDGS, plus ethanol, when using the traditional dry mill ethanol process. The economic viability of producing ethanol in a corn dry mill process is significantly improved with the process of the present invention. Economic analysis has shown that the process of the present invention has the potential to increase the revenues of dry mill ethanol production by $0.30 to $0.40 per bushel of corn processed.

Studies were performed to evaluate various corn varieties and qualify them for processing and determine the optimum conditions for dehulling and degerminating corn to recover the greatest quantity of low fat, low fiber endosperm. Experiments also were performed to identify those conditions (enzyme types and their addition points) during liquefaction, saccharification and fermentation of the endosperm that would result in the greatest yield of and highest protein content for the product of the invention (mid-level protein DDGS).

Thus, by way of illustration, high milk and high milk fat production achieved by dairy cattle and the improvements in feed efficiency and weight gain realized by beef cattle are attributable to the formulation of feeds that contain ingredients with high energy and bypass protein, excellent overall digestibility, and that stimulate the health and performance of the rumen digestive system. A high performance, low cost feed for dairy cattle that utilizes mid-level protein DDGS in its ingredient slate may be prepared with the following components:

| Ingredient | Percent of Composition |
|---|---|
| Corn | 70.0 |
| Soybean Meal | 11.3 |
| Mid-Level Protein DDGS | 10.0 |
| Meat and Bone/Blood Meal | 4.6 |
| Tallow | 1.1 |
| Calcium Phosphate | 1.6 |
| Magnesium Oxide | 0.2 |
| Salt | 0.6 |
| Vitamin/Mineral Mix | 0.3 |

By way of further illustration the formulation of diets for swine is a compromise between the selection of ingredients that meet the energy, protein, and mineral requirements of the animal at that point in its growth, at the lowest cost possible, and practical considerations, particularly control over the composition and quantity of waste generated by the animal. General formulas (% of composition) that incorporate mid-level protein DDGS and may be used in feeding swine include the following:

| Ingredient | Nursery Diet | Finishing Diet |
|---|---|---|
| Corn | 46 | 78 |
| Soybean Meal | 23 | 15 |
| Whey | 15 | — |
| Fish Meal | 6 | — |
| Mid-Level Protein DDGS | 5 | 5 |
| White Grease | 2.2 | — |
| Calcium Phosphate | 1 | 0.55 |
| Limestone | 0.5 | 0.75 |
| Salt | 0.3 | 0.3 |
| L-Lysine | 0.15 | 0.15 |
| DL-Methionine | 0.10 | — |
| Vitamin/Mineral Mix | 0.75 | 0.25 |

By way of yet further illustration, poultry rations are formulated to optimize reproductive performance, feathering, growth, and either egg production or meat quality at the lowest cost possible. The digestibility of and unidentified growth and health factors present in mid-level protein DDGS help achieve these objectives. General formulas (% of composition) that incorporate mid-level protein DDGS and may be used in poultry diets include the following:

| Ingredient | Layer Hen Diet | Turkey Diet (5-8 Weeks) |
|---|---|---|
| Corn | 62 | 60.1 |
| Soybean Meal | 20 | 20.5 |
| Poultry Meal | — | 8 |
| Mid-Level Protein DDGS | 4 | 6 |
| White Grease | 2.5 | 2 |
| Limestone | 8.5 | 0.75 |
| Calcium Phosphate | 1.15 | 1 |
| Salt | 0.35 | 0.05 |
| Choline Chloride | 0.50 | 0.15 |
| Vitamin/Mineral Mix | 1 | 0.75 |
| L-Lysine | — | 0.40 |
| Threonine | — | 0.10 |
| DL-Methionine | — | 0.20 |

By way of yet further illustration, the formulation of diets for farm-raised fish and crustaceans is often a compromise between the availability and cost of ingredients and practical considerations. The primary objective is to produce a feed that is: (i) nutritionally balanced to support maintenance, growth, reproduction and health, (ii) economical, (iii) palatable, (iv) stable in water, and (v) minimizes waste output and effect on water quality. General formulas (% of composition) that incorporate mid-level protein DDGS and may be used in aquaculture diets include the following:

| | Catfish | Shrimp | Tilapia |
|---|---|---|---|
| Ingredient | Formula | Formula | Formula |
| Corn | 23 | 20 | 44 |
| Wheat Middlings | 22 | — | — |
| Wheat Flour | — | 20.75 | — |
| Soybean Flour | — | — | 27 |
| Fish Meal | 4 | 13 | 6 |
| Soybean Meal | 31.8 | 30 | — |
| Meat and Bone/Blood Meal | 4 | — | — |
| Mid-Level Protein DDGS | 12.5 | 6 | 16 |
| Oil/Fat | 1.5 | — | 4 |
| Calcium Phosphate | 1.0 | — | — |
| Vitamin/Mineral Mix | 0.2 | 0.25 | 3 |
| Binder | — | 10 | — |

Although various embodiments of the present invention have been shown and described, it should be understood that other modifications, substitutions, and/or alternatives may be apparent to one skilled in the art. Such modifications, substitutions, and/or alternatives may be made without departing from the spirit and scope of the invention, which should be determined from the appended claims.

We claim:

1. An animal feed composition that is comprised of from about 1.5 to about 20.0 weight percent of a mid-level protein distillers dried grains with solubles (DDGS), wherein said mid-level protein DDGS is produced as a result of recovering and drying together the insoluble and soluble solids that remain after the enzymatic hydrolysis and alcoholic fermentation of the starch and non-starch carbohydrates present in the endosperm fraction of dry-milled corn; and wherein said mid-level protein DDGS has a: (a) starch content less than about 5.0 weight percent, (b) protein content of from about 40.0 to about 52.5 weight percent, (c) fat content of from about 4.5 to about 8.5 weight percent, (d) crude fiber content of from about 3.0 to about 6.0 weight percent, and (e) a total digestible nutrient value of from about 78.0 to about 90.0 percent.

2. The animal feed composition as recited in claim 1, wherein said animal feed composition is comprised of from about 2.5 to about 20.0 weight percent of said mid-level protein DDGS.

3. The animal feed composition as recited in claim 1, wherein said animal feed composition is comprised of from about 2.5 to about 15.0 weight percent of said mid-level protein DDGS.

4. The animal feed composition as recited in claim 1, wherein said animal feed composition is comprised of from about 1.5 to about 10.0 weight percent of said mid-level protein DDGS.

5. The animal feed composition as recited in claim 1, wherein said mid-level protein DDGS is comprised of from about 45.0 to about 50.0 weight percent protein, from about 3.5 to about 5.0 weight percent crude fiber, from about 6.0 to about 7.5 weight percent fat, and wherein said mid-level protein DDGS has a total digestible nutrient value of from about 80 to about 87.5 percent.

6. The animal feed composition as recited in claim 1, wherein said endosperm fraction used to produce said mid-level protein DDGS is derived from the dry-milling of a corn variety selected from the group consisting of yellow dent, hard endosperm yellow, white, flint, high amylose, waxy corn, and combinations thereof.

7. The animal feed composition as recited in claim 1, wherein said endosperm fraction used to produce said mid-level protein DDGS is derived from the dry-milling of a single variety or mixture of two or more varieties of yellow dent and/or hard endosperm yellow corn.

8. The animal feed composition as recited in claim 1, wherein said endosperm fraction used to produce said mid-level protein DDGS is derived from the dry-milling of a single variety or mixture of two or more varieties of flint and/or white corn.

9. The animal feed composition as recited in claim 1, wherein said mid-level protein DDGS is produced by a process comprising the steps of: (a) tempering clean, conditioned corn in water to loosen the attachment of the fractions consisting of the endosperm from the germ from the pericarp (hull), (b) dehulling and degerminating or decorticating said tempered corn to separate said endosperm from the germ from the pericarp (hull), (c) recovering said endosperm from the germ from the pericarp (hull), keeping as a single distinct fraction the large, medium and fine grits, and the meal and flour generated during said degermination or decortication of corn, (d) liquefying, saccharifying, and/or solubilizing the starch and non-starch carbohydrates present in said endosperm fraction, (e) performing an alcoholic fermentation using the fermentable sugars generated by the liquefaction, saccharification, and/or solubilization of the starch and non-starch carbohydrates present in said endosperm fraction, (f) removing the alcohol produced from said alcoholic fermentation, (g) separating the solids that remain after said alcoholic fermentation and/or solubilization of starch and non-starch carbohydrates and said alcohol recovery into an insoluble solids and soluble solids fraction, (h) concentrating said soluble solids fraction into a high solids-containing syrup, and (i) recovering and combining said insoluble solids fraction and the high solids-containing syrup produced from said soluble solids fraction and together drying said insoluble and soluble solids fraction to produce said mid-level protein DDGS.

10. The animal feed composition as recited in claim 9, wherein said step of tempering clean, conditioned corn, as part of the process to produce said mid-level protein DDGS, is done with water at ambient temperature to increase the moisture content of the corn from a range of about 12.0 to about 15.0 weight percent to a range of about 17.0 to about 22.0 weight percent.

11. The animal feed composition as recited in claim 9, wherein said step of tempering clean, conditioned corn, as part of the process to produce said mid-level protein DDGS, is done with water at ambient temperature for a period of from about 0.33 to about 8.0 hours.

12. The animal feed composition as recited in claim 9, wherein said step of dehulling and degermination or decortication of corn, as part of the process to produce said mid-level protein DDGS is done with machinery that through impaction, abrasion, and/or shearing separates said tempered corn into fractions comprising endosperm, germ and pericarp (hull).

13. The animal feed composition as recited in claim 9, wherein said step of recovering endosperm from the germ and from the pericarp (hull), as part of the process to produce said mid-level protein DDGS, is performed by sieves or screens, gravity tables, and/or aspirators, and wherein said recovered endosperm contains, as a single distinct fraction, all of the large, medium, and small grits, and the meal and flour generated during said dehulling and degerminating or decorticating of corn.

14. The animal feed composition as recited in claim 9, wherein said recovered endosperm, as part of the process to produce said mid-level protein DDGS, represents from about 65.0 to about 80.0 weight percent of said tempered corn.

15. The animal feed composition as recited in claim 9, wherein said recovered endosperm, as part of the process to produce said mid-level protein DDGS, has a fat content from about 0.70 to about 1.10 weight percent and a crude fiber content from about 0.40 to about 0.80 weight percent.

16. The animal feed composition as recited in claim 9, wherein said liquefaction, saccharification and/or solubilization of the starch and non-starch carbohydrates present in said endosperm, as part of the process to produce said mid-level protein DDGS, is performed by an acid-acid, acid-enzyme, or enzyme-enzyme process.

17. The animal feed composition as recited in claim 9, wherein said liquefaction, saccharification and/or solubilization of the starch and non-starch carbohydrates present in said endosperm, as part of the process to produce said mid-level protein DDGS, is performed via an enzyme-enzyme process with enzymes selected from the group consisting of amylases, glucoamylases, cellulases, hemicellulases, beta-glucanases, and mixtures thereof.

18. The animal feed composition as recited in claim 9, wherein said alcoholic fermentation of the fermentable sugars obtained from the liquefaction, saccharification and/or solubilization of the starch and non-starch carbohydrates present in said endosperm, as part of the process to produce said mid-level protein DDGS, is performed by a single or mixed culture of either yeast or bacteria.

19. The animal feed composition as recited in claim 9, wherein the recovery of said insoluble solids that remain after said alcoholic fermentation and said alcohol recovery, as part of the process to produce said mid-level protein DDGS, is performed by sedimentation, filtration, centrifugation, and combinations thereof.

20. The animal composition as recited in claim 9, wherein said soluble solids that remain after said alcoholic fermentation and said alcohol recovery, as part of the process to produce said mid-level protein DDGS, are concentrated to a high solids-containing syrup using membrane filtration, evaporation, and combinations thereof.

21. The animal feed composition as recited in claim 9, wherein said insoluble solids and said soluble solids that remain after said alcoholic fermentation and said alcohol recovery, as part of the process to produce said mid-level protein DDGS, are combined and dried together in a dryer selected from the group consisting of a spray dryer, flash dryer, ring dryer, freeze dryer, vacuum dryer, rotary gas-fired dryer and rotary steam-tube dryer.
